(19) United States
(12) Patent Application Publication
(10) Pub. No.: US 2010/0150386 A1
(43) Pub. Date: Jun. 17, 2010

(54) UNIVERSAL SERIAL BUS INTERFACES FOR A HEARING AID

(75) Inventors: Dan Edgar, Lakeville, MN (US); David A. Preves, Bradenton, FL (US)

Correspondence Address: SCHWEGMAN, LUNDBERG & WOESSNER, P.A., P.O. BOX 2938, MINNEAPOLIS, MN, 55402, US

(73) Assignee: Starkey Laboratories, Inc.

(21) Appl. No.: 12/336,444

(22) Filed: Dec. 16, 2008

(51) Int. Cl. H04R 25/00

(52) U.S. Cl. 381/315

(57) ABSTRACT

A hearing aid comprising a microphone, processing electronics connected to the microphone, a housing enclosing the processing electronics, a wireless USB controller connected to the processing electronics Other examples include method and apparatus of hearing aids with a wired USB port.

### FIELD

The present application relates to hearing aids and more particularly to hearing assistance aids with Universal Serial Bus (USB) enabled ports.

### BACKGROUND

Current hearing aid technology allows a particular hearing aid electronics package to be customized for a wide range of hearing correction requirements. As a user's hearing changes when using a hearing aid, the performance parameters can usually be modified to accommodate the hearing change. Modification of the hearing aid performance either to initialize a hearing aid or adjust its past configuration, require the use of a programmer. Often the programmer is of a custom design or utilizes custom communication protocols.

What is needed in the art is a hearing aid which can be programmed using a standard connection and communication protocol without the need for a dedicated programmer.

### SUMMARY

The above-mentioned problems and others not expressly discussed herein are addressed by the present subject matter and will be understood by reading and studying this specification.

The present subject matter includes method and apparatus of hearing aids comprising a microphone, processing electronics connected to the microphone, a housing enclosing the processing electronics, a USB controller connected to the processing electronics and a USB port connected to the USB controller. The USB controller includes instructions for configuring the USB port as a USB host. Additional embodiments include a method comprising connecting a hearing aid to a peripheral USB device using a Universal Serial Bus port of the hearing aid and electronically communicating with the peripheral USB device using the hearing aid as a host USB device. Various embodiments include a hearing aid with a wired USB port. Various embodiments include a hearing aid with a wireless USB port. A method embodiment includes wirelessly connecting a hearing aid to a peripheral USB device using a Universal Serial Bus protocol and transferring data between the hearing aid and the peripheral device. Various embodiments include transferring data between the hearing aid and a mobile device such as a cell phone including using a USB protocol for programming the hearing aid with the cell phone.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 shows a USB-enabled hearing aid according to one embodiment of the present subject matter.

FIG. 2 shows a USB-OTG enabled hearing aid, according to one embodiment of the present subject matter, connected to a second hearing aid with a USB cable.

FIG. 3 shows a hearing aid according to the present subject matter connected to a host computer.

FIG. 4 is a block diagram of a USB-OTG hearing aid according to the present subject matter connected to a cell phone.

FIG. 5 shows a first wireless USB enabled hearing aid according to one embodiment of the present subject matter in wireless communication with a second wireless USB enabled hearing aid.

FIG. 6 shows a hearing aid according to one embodiment of the present subject matter in wireless communication with a computer.

FIG. 7 shows a wireless USB enabled hearing aid according to the present subject matter connected to a cell phone.

### DETAILED DESCRIPTION

The following detailed description of the present subject matter relates to the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

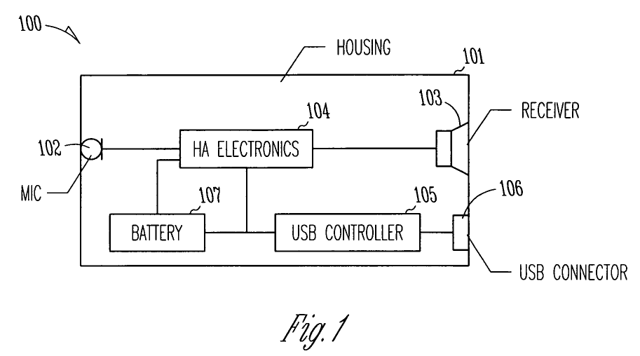

FIG. 1 shows a USB-enabled hearing aid 100 according to one embodiment of the present subject matter. The hearing aid 100 includes a housing 101 enclosing a microphone 102, a receiver 103, hearing aid electronics 104 and a USB controller 105 connected to a USB port 106. The USB controller 105 is configured with program instructions according to Revision 1.3 of the On-the-Go (OTG) supplement to the USB 2.0 specification which are incorporated herein in their entirety. The USB-OTG controller 102 allows the hearing aid to connect to USB devices as either a peripheral USB device or a limited function USB host device. Therefore, the hearing aid 100 can connect to a remote USB device, and the remote USB device can be either a host computer or a peripheral device. USB peripheral devices include, but are not limited to, cell phones, PDAs, printers, displays or a second hearing aid. In one embodiment, the host capabilities of the USB-OTG enabled hearing aid 100 are used to connect the hearing aid to a USB enabled monitor to display stored data including, but not limited to, parameters of the hearing aid and waveforms of recorded sounds. In various embodiments, communication with peripheral devices is accomplished using a wireless connection. In another example, the host capabilities of the hearing aid are used to connect to a printer to print a status report.

The illustrated embodiment of FIG. 1 uses the self-powered features of the USB specification to recharge the hearing aid battery 107 eliminating, in most cases, the need for a user to purchase a battery charger to charge the hearing aid battery 107. The USB-OTG supplement to the USB 2.0 specification includes cables and connectors such that USB-OTG controllers can be used with various hearing aid housings including, but not limited to, behind-the-ear (BTE), in-the-ear (ITE), in-the-canal (ITC), completely-in-the-canal (CIC) and housings used with receiver-in-the-canal (RIC) hearing aids. In various embodiments, custom made connectors and cables are used.

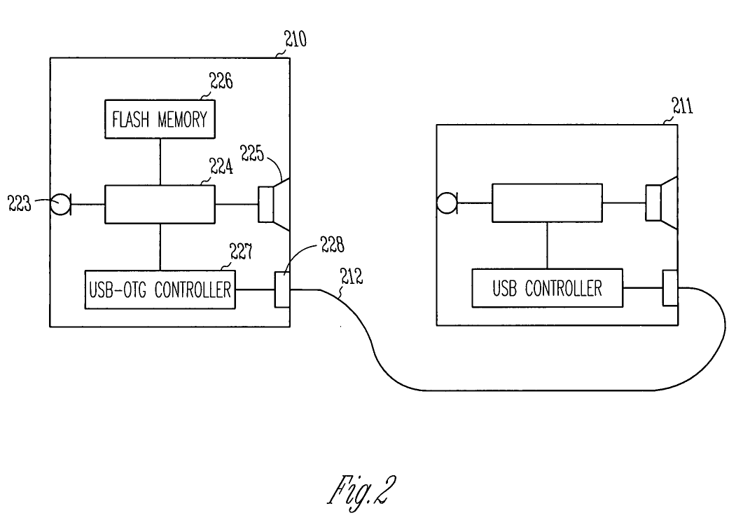

FIG. 2 shows a USB-OTG enabled hearing aid 210, according to one embodiment of the present subject matter, connected to a second hearing aid 211 with a USB cable 212. The USB-OTG enabled hearing aid 210 includes a microphone 223, a receiver 225, flash memory 226 and a wireless USB-OTG controller 227 with a USB port 228 connected to hearing aid electronics 224. The USB-OTG enabled hearing aid 210 is connected to the other hearing aid 211 with a USB cable 212. Connecting one hearing aid to another hearing aid over a USB-OTG connection allows the hearing aids to exchange data and data files including, but not limited to, audio data and audio data files. In various embodiments, hearing aids connected using a USB-OTG connection can hot sync data in one hearing aid with data in the other hearing aid. Such a feature can be used to update firmware of a hearing aid or reset hearing aid parameters. In various embodiments, the hearing aids include flash memory such that entertainment files containing audio content including, but not limited to, .mp3 and .wav files, can be exchanged for sharing.

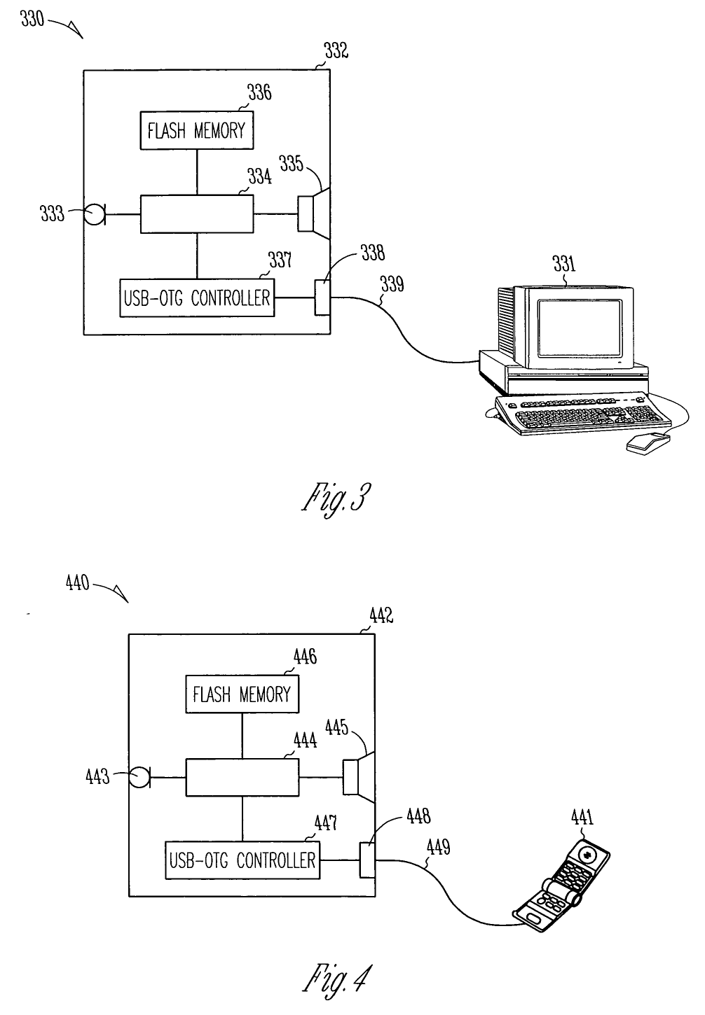

FIG. 3 shows a hearing aid 330 according to the present subject matter connected to a host computer 331. The hearing aid 331 includes a microphone 333, hearing aid electronics 334, a receiver 335, flash memory 336 and a USB-OTG controller 337 connected to a USB port 338. The hearing aid is connected to the computer with a USB cable 339. The hearing aid's USB-OTG controller is adapted to allow the computer 331 to program, edit and monitor the operation of hearing aid 330 through parameters stored in the hearing aid's flash memory 336. Connecting the hearing aid to the computer eliminates the need for a separate programmer for the hearing aid. During normal operation the hearing aid's processing electronics 334 access the flash memory 336 and provide hearing aid according to the parameters stored thereon. In various embodiments, the flash memory 334 is partitioned such that a portion of the memory is available for general storage of data. When connected to a host device, such as the personal computer 331, the USB-OTG controller allows the general storage portion of the memory 336 to be mapped on the computer 331 as a mass storage device to store and retrieve data using USB Mass Storage protocols according to the Universal Serial Bus 2.0 Specification which is incorporated herein by reference in its entirety.

FIG. 4 is a block diagram of a USB-OTG hearing aid 440 according to the present subject matter connected to a cell phone 441. The USB-OTG enabled hearing aid 440 includes a housing 442, microphone 443, processing electronics 444, a receiver 445, flash memory 446 and a USB-OTG controller 447 connected to a USB port 448. The hearing aid 440 is connected to the USB enabled cell phone 441 using a USB cable 449. In various embodiments, connecting the hearing aid 440 and cell phone 441 using a USB-OTG communication link exploits features of the devices to provide a number of new or improved functions. These functions include, but are not limited to, placing cell phone telephone calls where audio is played to the user's ear using the hearing aid receiver and, thus, compensating for a user's hearing impairment, if any, streaming audio from an audio file on the cell phone through the hearing aid receiver, exchanging data files between the hearing aid 440 and the cell phone 441, and programming, editing or monitoring the operation of the hearing aid 440 using the cell phone 441. Using the cell phone to program, edit and monitor the hearing aid through the USB communication link reduces the need for a separate hearing aid programmer, as is commonly required.

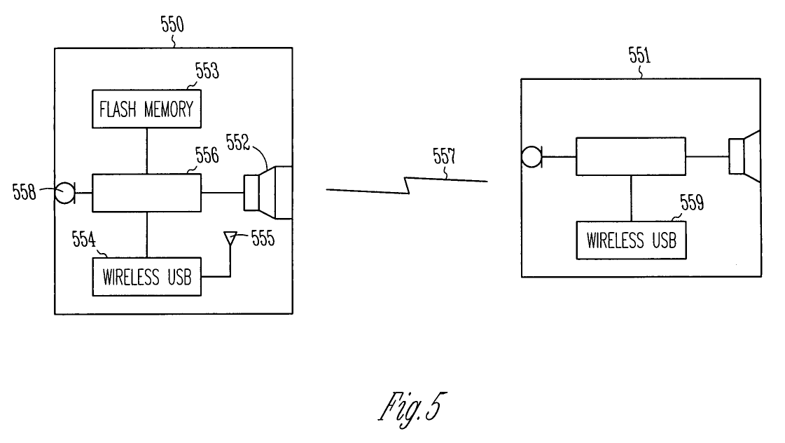

FIG. 5 shows a first wireless USB enabled hearing aid 550, according to one embodiment of the present subject matter in wireless communication with a second wireless USB enabled hearing aid 551. The first hearing aid includes a microphone 551, a receiver 552, flash memory 553 and a wireless USB controller 554 with an attached antenna 555 connected to hearing aid electronics 556. Connecting one hearing aid to another hearing aid over a wireless USB connection 557 allows the hearing aids to exchange data and data files including, but not limited to, audio data and audio data files. In various embodiments, hearing aids connected using a wireless USB connection can hot sync data in one hearing aid with data in the other hearing aid. Such a feature can be used to update firmware of a hearing aid or reset hearing aid parameters. In various embodiments, the hearing aids include flash memory such that files containing audio content including, but not limited to, .mp3 and .wav files, can be exchanged for sharing. In various embodiments, the wireless USB controllers 554, 559 operate using short range Ultra Wide Band (UWB) wireless communications according to the WiMedia Alliance Certified Wireless USB (WUSB) protocol. Such communications include carrier frequencies spreading from about 3.1 gigahertz (GHz) to about 10.6 GHz. In some embodiments, wireless USB enable devices quickly connect with each other without pairing into a full wireless communications environment at ranges up to about 10 feet with speed up to about 480 megabytes per second (MB/s), and up to about 33 feet at speeds up to about 110 MB/s.

Wireless USB/Ultra-Wideband chip sets are available from a number of manufacturers including, but not limited to, WiQuest (1 Gbit/s data rate), Metalink and Alereon. The 0.18 μm, radio frequency, complementary metal-oxide-semiconductor (RFCMOS) process is the best suited for WUSB. For example, the WUSB design from Jazz Semiconductor requires 9 mw@1.8 v and occupies 0.22 mm² die area. The 0.13 μm RFCMOS and 0.18 μm SiGe processes are also viable WUSB design processes.

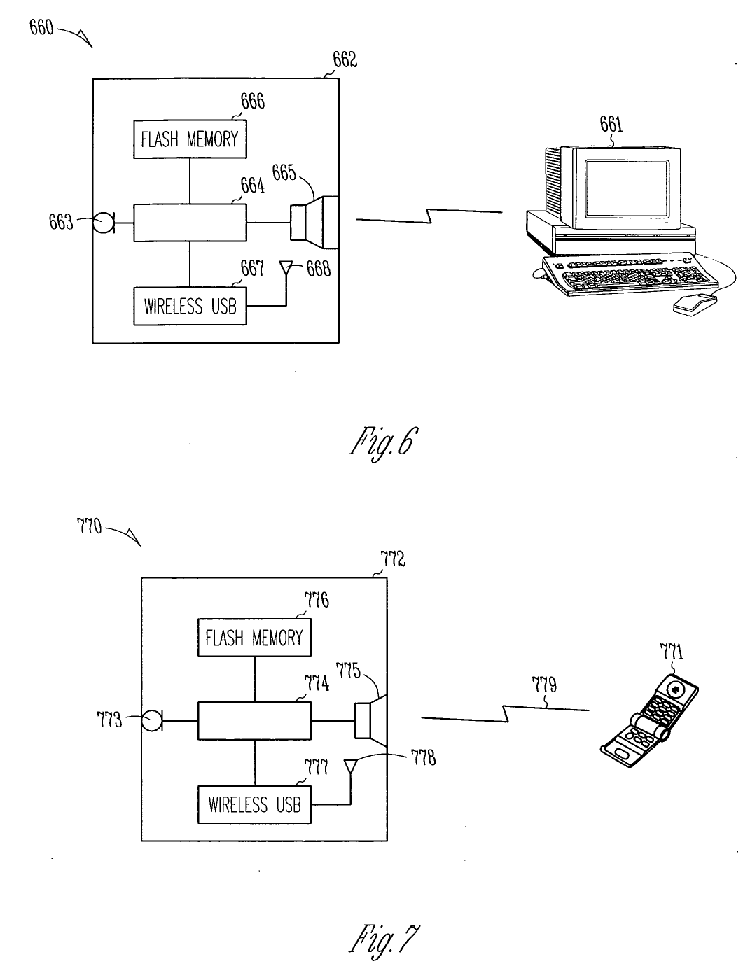

FIG. 6 shows a hearing aid 660 according to one embodiment of the present subject matter in wireless communication with a computer 661. The computer is a general purpose computer such as a desktop computer or a laptop computer. The hearing aid 661 includes a housing 662, a microphone 663, hearing aid electronics 664, a receiver 665, flash memory 666 and wireless USB controller 667 connected an antenna 668. The hearing aid's wireless USB controller 667 is adapted to allow the computer 661 to program, edit and monitor the operation of hearing aid 660 through parameters stored in the hearing aid's flash memory 666. Connecting the hearing aid to the computer eliminates the need for a separate programmer for the hearing aid. The processing electronics 664 access the flash memory 666 and provide hearing assistance according to parameters stored thereon. In various embodiments, the flash memory 664 is partitioned such that a portion of the memory is available for general storage of data. When connected to another device, such as the personal computer 661, the wireless USB controller allows the general storage portion of the memory 666 to be mapped on the computer 661 as a mass storage device for storing and retrieving data including, but not limited to, audio data and audio files. In various embodiments, the hearing aid includes other memory circuits but does not include flash memory. In some embodiments, flash memory may be added to the hearing aid as an option. In embodiments without flash memory, the processing electronics 664 access the other memory and provide hearing assistance according to the parameters stored thereon. Additionally, the wireless USB controller is adapted to allow the computer 661 to program, edit and monitor the operation of hearing aid 660 through parameters stored in memory.

FIG. 7 shows a block diagram of a wireless USB enabled hearing aid 770 according to the present subject matter connected to a cell phone 771. The wireless USB enabled hearing aid 770 includes a housing 772, microphone 773, processing electronics 774, a receiver 775, flash memory 776 and a wireless USB controller 777 connected to an antenna 778. In various embodiments, connecting the hearing aid 770 and cell phone 771 using a wireless USB communication link 779 exploits features of both devices to provide a number combined functions. These functions include, but are not limited to, placing cell phone telephone calls where audio is played to the user's ear using the hearing aid receiver and, thus, compensating for a user's hearing impairment, streaming audio from an audio file on the cell phone through the hearing aid receiver, exchanging data files between the hearing aid 770 and the cell phone 771, and programming, editing or monitoring the operation of the hearing aid 770 using the cell phone 771. Using the cell phone to program, edit and monitor the hearing aid through the wireless USB communication link 779 reduces the need for a separate hearing aid programmer, as is commonly required.

It is understood that the foregoing teachings may be employed in different hardware, firmware, or software configurations and combinations thereof. It is understood that the embodiments set forth herein may be employed in different types of hearing aids. Such hearing aids may include, but are not limited to, behind-the-ear, in-the-ear, and completely-in-the-canal designs. Other applications of the foregoing teachings are possible without departing from the scope of the present subject matter.

This application is intended to cover adaptations and variations of the present subject matter. It is to be understood that the above description is intended to be illustrative, and not restrictive. The scope of the present subject matter should be determined with reference to the appended claim, along with the full scope of equivalents to which the claims are entitled.

What is claimed is:

1. A hearing aid comprising;
a microphone;
processing electronics connected to the microphone;
a housing enclosing the processing electronics; and
a wireless USB controller connected to the processing electronics.

2. The hearing aid of claim 1, wherein the housing is a behind-the-ear housing.

3. The hearing aid of claim 2, further comprising a receiver connected to the processing electronics, the receiver adapted to fit in a wearer's ear canal.

4. The hearing aid of claim 1, wherein the housing is an in-the-ear housing.

5. The hearing aid of claim 1, wherein the housing is an in-the-canal housing.

6. The hearing aid of claim 1, wherein the housing is a completely-in-the-canal housing.

7. The hearing aid of claim 1, further comprising flash memory connected to the processing electronics.

8. A method comprising:
wirelessly connecting a hearing aid to a Universal Serial Bus (USB) device using a USB protocol; and
transferring data between the USB device and the hearing aid.

9. The method of claim 8, wherein wirelessly connecting includes wirelessly connecting the hearing aid to a USB monitor and the method further comprises displaying data from the hearing aid.

10. The method of claim 8, wherein wirelessly connecting includes wirelessly connecting the hearing aid to a cell phone and wherein transferring data includes transferring data between the hearing aid and the cell phone.

11. The method of claim 10, further comprising programming the hearing aid using the cell phone.

12. The method of claim 8, wherein wirelessly connecting includes wirelessly connecting the hearing aid to a cell phone and wherein transferring data includes streaming audio data between the hearing aid and the cell phone.

13. The method of claim 8, wherein wirelessly connecting includes wirelessly connecting the hearing aid to a second hearing aid and wherein transferring data includes transferring data between the hearing aid and the second hearing aid.

14. The method of claim 13, wherein wireless connecting includes wirelessly connecting the hearing aid to the second hearing aid as a host USB device.

15. The method of claim 14, further comprising programming the second hearing aid using programming data from the hearing aid.

16. The method of claim 13, wherein transferring data includes transferring audio data.

17. The method of claim 16, wherein transferring audio data includes streaming audio data between the hearing aid and the second hearing aid.

18. The method of claim 8, wherein the USB device is a computer and wherein transferring data includes transferring data between the hearing aid and the computer.

19. The method of claim 18, further comprising programming the hearing aid using the computer.

20. The method of claim 18, wherein transferring data includes transferring audio files.
